(19) United States
(12) Patent Application Publication
(10) Pub. No.: US 2006/0008785 A1
(43) Pub. Date: Jan. 12, 2006

(54) Method of and system for interacting with cognitively impaired individuals

(76) Inventors: William Clark, Centennial, CO (US); Brian Rafferty, Edmonds, WA (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/888,719

(22) Filed: Jul. 9, 2004

(51) Int. Cl. G09B 19/00

(52) U.S. Cl. 434/236

(57) ABSTRACT

A method is provided which in one embodiment can interact with cognitively impaired individuals for various purposes, such as entertainment, education, exercise, and therapeutic treatment. In particular, a method is provided for entertaining or educating cognitively impaired individuals, such as those suffering from Alzheimer's disease. In one embodiment, a sensory presentation can be provided to a cognitively impaired individual to assist the individual in generating a cognitive, emotional, or physical response to the sensory presentation. In an exemplary embodiment, the sensory presentation can be produced based on one or more of the cognitive, cognitive-perceptual, and/or functional abilities retained by the cognitively impaired individuals. Additionally or alternatively, a device and a system is provided to interact with cognitively impaired individuals.

### FIELD OF THE INVENTION

The present invention relates generally to a method of and a system for interacting with cognitively impaired individuals. In particular, the present invention relates to a method of and a system for providing entertainment or education to cognitively impaired individuals, such as those suffering from Alzheimer's disease. The present invention also relates to a sensory presentation device and a method of preparing a sensory presentation for interacting with cognitively impaired individuals.

### BACKGROUND OF THE INVENTION

People with acute, chronic, or degenerative cognitive or cognitive-perceptual deficits and their associated functional deficits can suffer from delirium, dementia, or other cognitive, cognitive-perceptual, or functional impairment. Such cognitive or cognitive-perceptual impairment can result from (a) medical conditions; (b) medical interventions; (c) mental illness; (d) pain, nausea, or other symptoms that impair concentration; or (e) Alzheimer's disease or other dementias and neurological disorders. Due to the cognitive or cognitive-perceptual deficits, cognitively impaired individuals often find mainstream commercial content demanding, confusing, or aversive.

In addition, because many day-to-day experiences are effectively beyond their cognitive, cognitive-perceptual or functional abilities, cognitively impaired individuals often have failure experiences in activities of daily living. Consequently, the resulting cognitive-emotional or behavioral disturbances, such as aggression, wandering, sleep disturbance, or other manifestations of agitation, can affect the quality of life for both the cognitively impaired individuals and their caregivers.

For example, Alzheimer's disease (AD) is the most common form of dementia afflicting an estimated four million Americans. AD patients can experience pervasive cognitive and perceptual declination, which limits the perceptual and cognitive-linguistic pathways through which AD patients interact with their environment. Such limitations can isolate AD patients, often resulting in anxiety, depression, and withdrawal.

The present invention can provide a method of and a system for interacting with cognitively impaired individuals. In particular, the present invention can provide a method of and a system for entertaining or educating cognitively impaired individuals, such as those suffering from Alzheimer's disease. The present invention can also provide a sensory presentation device and a method of preparing a sensory presentation for interacting with cognitively impaired individuals.

### SUMMARY OF THE INVENTION

According to one aspect of the present invention, a method can be provided for preparing a sensory presentation for interacting with cognitively impaired individuals for various purposes, such as entertainment, education, exercise, or therapeutic treatment. In one embodiment, the method can comprise preparing the sensory presentation based on one or more cognitive, cognitive-perceptual, and/or functional abilities retained by a group of cognitively impaired individuals of concern. Additionally or alternatively, the method for preparing the sensory presentation can comprise developing one or more production guidelines based on such retained abilities of the cognitively impaired individuals. In an exemplary embodiment, the sensory presentation can be prepared based on one or more of the production guidelines. The sensory presentation, after being presented to a cognitively impaired individual of the group, is capable of assisting the individual in generating a cognitive, emotional, or physical response to the sensory presentation.

According to another aspect of the present invention, a sensory presentation device can be provided for interacting with cognitively impaired individuals. In one embodiment, the sensory presentation device can comprise a sensory presentation formed on a medium, such as a compact disc, video tape, book, or the like. The sensory presentation can be in various manners and structures. In an exemplary embodiment, the sensory presentation can comprise various visual and auditory contents. In another exemplary embodiment, the sensory presentation can comprise one or more themes, each of which can comprise one or more topics. The sensory presentation, including the themes and the topics, can be prepared based on one or more of the production guidelines, which are in turn formed based on the retained cognitive, cognitive-perceptual, and/or functional abilities of the cognitively impaired individuals.

According to a further aspect of the invention, a system can be provided for interacting with cognitively impaired individuals, such as for entertaining or educating AD patients. In one embodiment, the system can comprise a primary sensory device and an ancillary sensory device for providing a sensory presentation to a cognitively impaired individual. The primary and ancillary sensory devices can comprise at least one common theme. In an exemplary embodiment, the primary and ancillary sensory devices can engage the cognitively impaired individual in generating a cognitive, emotional, or physical response to the sensory presentation.

According to a still further aspect of the invention, a method can be provided for interacting with cognitively impaired individuals. In one embodiment, the method can comprise providing a first sensory presentation to a cognitively impaired individual. In an exemplary embodiment, the first sensory presentation can be prepared in various manners and forms, which can be similar to or the same as those of the sensory presentation discussed above. In another exemplary embodiment, the method can comprise providing a priming signal to cue the individual to generate a cognitive, emotional, or physical response to the sensory presentation. Additionally or alternatively, the method can comprise providing a second sensory presentation to the cognitively impaired individual, such as affording the individual a different and additional experience of the first sensory presentation. The method can be carried out in various manners to achieve various results, including but not limited to, entertainment, education, exercise or therapeutic treatment.

### BRIEF DESCRIPTION OF THE DRAWING

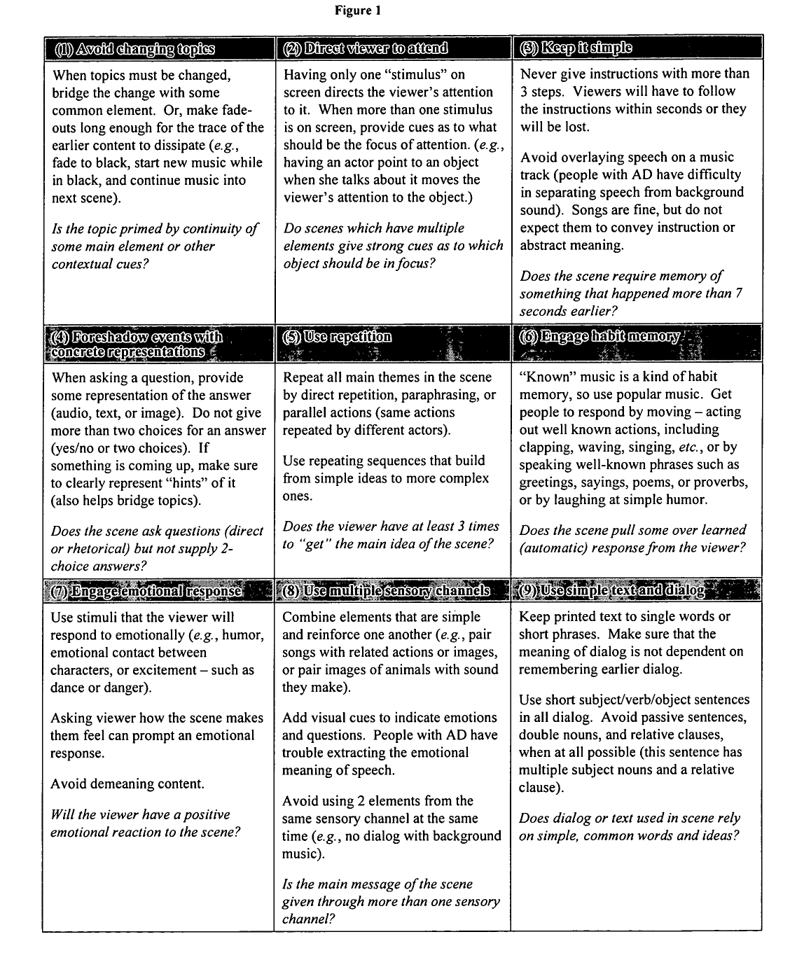

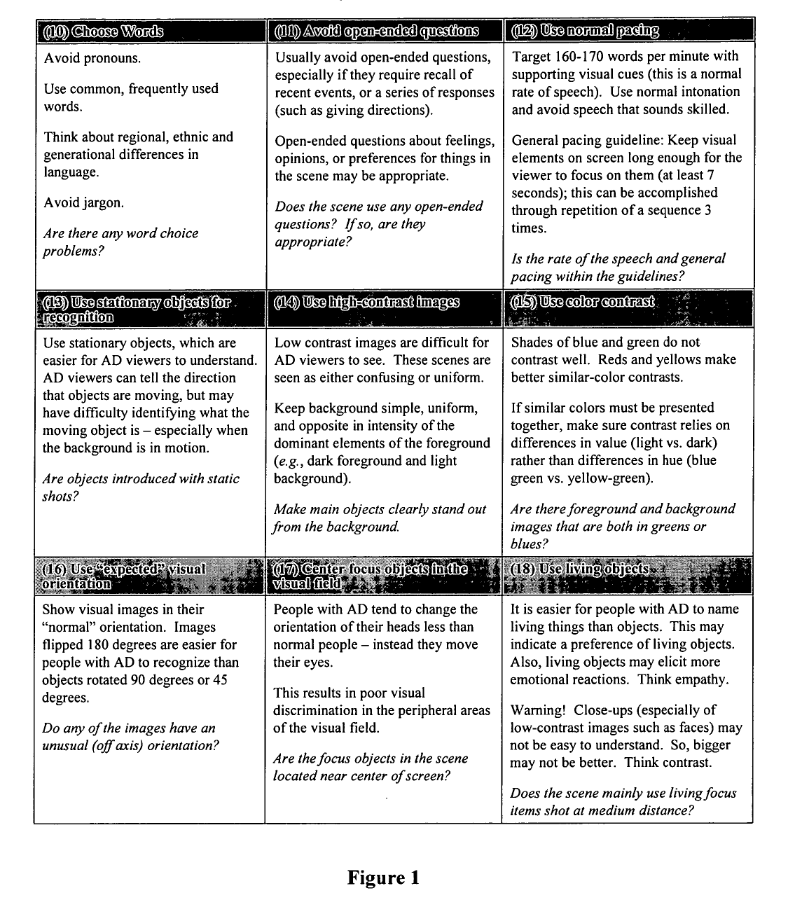

The detailed description of the present invention will be better understood in conjunction with the accompanying drawing, which contains FIG. 1 showing a set of production guidelines formed in accordance with the present invention.

### DETAILED DESCRIPTION OF THE INVENTION

Exemplary methods, devices, and systems embodying the principle of the present invention will now be described in conjunction with the companying drawing. It should be understood that the exemplary methods, devices, or systems described are not to be considered limiting and various features from the different embodiments can be considered.

According to one aspect of the present invention, a method can be provided for preparing a sensory presentation for interacting with cognitively impaired individuals for various purposes, such as entertainment, education, exercise, or therapeutic treatment. For example, the sensory presentation can comprise various sensory signals, such as visual and auditory signals, to be shown to a recipient through various sensory channels, such as visual and auditory channels. After being presented to a cognitively impaired individual, the sensory presentation is capable of assisting the individual in generating a cognitive, emotional, or physical response to the sensory presentation.

In one embodiment, the sensory presentation can be formed based on one or more cognitive, cognitive-perceptual, and/or functional abilities retained by a group of cognitively impaired individuals of concern. Depending on the cognitive impairment that the group of individuals can have, different retained cognitive, cognitive-perceptual, and/or functional abilities can be used as a basis for preparing or designing the sensory presentation. For example, one or more of the following cognitive, cognitive-perceptual, and/or functional abilities can be used for AD patients: sustained attention, selective attention, working or short-term memory, long-term memory, habit memory, ability to learn new habits, response to conditioning, response to new stimuli, reading and writing ability, ability to understand and respond to gestures, ability to follow multiple step commands, ability to answer questions, ability to understand grammar, syntax, and automatic phrases, auditory prosidy processing, auditory attention, visual spatial contrast sensitivity, static visual acuity, stereoacuity, dynamic visual acuity, motion direction discrimination, visual attention, visual shape-from-motion, color discrimination, visuospatial construction, and visual memory, and functional ability to perform activities of daily living. It will be appreciated that other retained cognitive, cognitive-perceptual, and/or functional abilities can be used to prepare the sensory presentation for AD patients or other cognitively impaired individuals and are also within the scope of the present invention.

In one exemplary embodiment, the method for preparing the sensory presentation can comprise identifying one or more cognitive, cognitive-perceptual, and/or functional abilities retained by a group of cognitively impaired individuals having a similar type of cognitive impairment. For example, one or more of the above mentioned cognitive, cognitive-perceptual, and/or functional abilities, such as memory, visual, and auditory perceptual abilities, can be identified that typically remain or show relatively less disability in Alzheimer's disease. It will be appreciated that different cognitive, cognitive-perceptual, and/or functional abilities can be identified in different types of cognitively impaired individuals and/or at different stages of a particular type of cognitive, cognitive-perceptual, or functional impairment (e.g., the mild, moderate, or severe stage of Alzheimer's disease), which are also within the scope of the present invention.

Additionally or alternatively, the method for preparing the sensory presentation can comprise developing one or more production guidelines based on the retained cognitive, cognitive-perceptual, and/or functional abilities identified. For example, in the case of AD patients, the production guidelines can be developed based on one or more of the retained cognitive and/or cognitive-perceptual abilities identified above. Exemplary production guidelines can be categorized as follows: avoiding changing topics, directing recipients to attend to stimuli, keeping it simple, foreshadowing events with concrete representations, using repetition, engaging habit memory, engaging emotional response, using multiple sensory channels, using printed text and simple dialog, using word choice, avoiding open-ended questions, using normal pacing, using stationary objects for recognition, using high-contrast images, using color contrast, using expected visual orientation, centering focus objects in the visual field, and using living objects. It will be appreciated that other production guidelines can be used to prepare sensory presentations for AD patients or other cognitively impaired individuals and are also within the scope of the present invention.

FIG. 1 shows an exemplary set of production guidelines formed in accordance with the present invention. In an exemplary embodiment, such as shown in FIG. 1, eighteen categories of production guidelines can be provided. For example, each category of the production guidelines can comprise one or more instructions. In an exemplary embodiment, in the category of “use multi-sensory channels”, the following instructions can be provided: “combine elements that are simple and reinforce one another”, “add visual cues to indicate emotions and questions”, and “avoid using two elements from the same sensory channel at the same time.” In another exemplary embodiment, one or more production instructions can be formed as a question. For example, one instruction in the above category can be formed as a question, such as “Is the main message of the scene given through more than one sensory channel?”. Various other production guidelines and instructions will be discussed in greater detail below. It will be appreciated that other instructions can be formed as production guidelines and are also within the scope of the present invention.

In one exemplary embodiment, the sensory presentation can be prepared based on one or more production guidelines. For example, the sensory presentation can be formed to be received by multiple sensory channels of the cognitively impaired individual. In an exemplary embodiment, the sensory presentation can be both seen and heard. For example, the sensory presentation can pair songs with related actions or images or pair images of animals with sounds that the animals make. In another exemplary embodiment, after the sensory presentation is first formed, the sensory presentation can be reviewed to ensure that it is presented through more than one sensory channel. In a further exemplary embodiment, the sensory presentation can be formed that no two auditory signals are provided simultaneously. For example, dialog and background sound effect can be separated from each other and presented at different times in a sensory presentation. Additional and other methods of preparing the sensory presentation will be discussed in great detail below.

According to another aspect of the present invention, a sensory presentation device can be provided for interacting with cognitively impaired individuals. In one embodiment, the sensory presentation device can comprise a sensory presentation formed on a medium, such as compact disc, video tape, book, or the like. For example, the sensory presentation can be recorded on a DVD. It will be appreciated that other forms of the medium are also within the scope of the present invention.

The sensory presentation can be formed in various manners and forms. In an exemplary embodiment, a host can be employed to present at least a portion of the sensory presentation. In another exemplary embodiment, one or more animated characters can be used either alone or together with a host. Additionally or alternatively, the sensory presentation can comprise various visual and/or auditory presentations in either a stationary or a moving state. In an exemplary embodiment, the visual presentation can comprise an image, such as of a person, an animal, an object, a scenery, and the like. In another exemplary embodiment, the visual presentation can comprise a text content, such as a quote or a question. In a further exemplary embodiment, the auditory presentation can comprise a recorded presentation, such as music or dialog. In a still further exemplary embodiment, the sensory presentation can have a multi-medium form and be shown by a multimedia device. In a further exemplary embodiment, the sensory presentation can comprise a continuous multi-sensory signal.

In another exemplary embodiment, the sensory presentation can be formed based on one or more of the production guidelines. In an exemplary embodiment, the sensory presentation can be prepared to engage emotional responses from the recipient. For example, use stimuli that a recipient will respond to emotionally, such as humor, emotional contact between characters, or excitement. In another exemplary embodiment, the sensory presentation can be prepared to engage habit memory. For example, prepare a sensory presentation so that the response from a cognitively impaired recipient can be any of the following: acting out common moves, such as clapping, waving, singing, or the like; or speaking well-known phrases, such as greetings, proverbs, or the like.

Additionally or alternatively, when an image is used in the sensory presentation, one or more production guidelines can be followed. In an exemplary embodiment, keep the focus objects in the image near the center of the visual field. In another exemplary embodiment, keep the objects stationary, if possible. In a further exemplary embodiment, the image can be formed with a high background-foreground contrast, such as a dark and high intensity foreground on a simple, uniform, light background. In a still further exemplary embodiment, use color contrast in the image, instead of shade contrast. In a preferred embodiment, the sensory presentation can be formed to completely conform to one or more of the production guidelines. It will be appreciated that other manners and/or forms of the sensory presentation are also within the scope of the present invention.

Additionally or alternatively, the sensory presentation can have various structures. In one exemplary embodiment, the sensory presentation can comprise one or more themes prepared based on one or more cognitive, cognitive-perceptual, and/or functional abilities retained by the cognitively impaired individuals. For example, each theme can relate to one or more subjects. In one exemplary embodiment, the theme can comprise a subject of interest to the cognitively impaired individuals. In another exemplary embodiment, at least one theme can be based on a subject familiar to the cognitively impaired individuals. For example, the theme can be based on family life, romance, pets, holidays, trips, or any other subjects familiar to an intended recipient. It will be appreciated that other subjects can also be used as the themes and are within the scope of the present invention.

The themes can have various structures. In one exemplary embodiment, at least one of the one or more themes can comprise one or more topics, which will be described in great detail below. In an exemplary embodiment, an opening section can be provided for at least one of the themes. For example, each opening section can comprise visual and/or auditory signals to indicate the beginning of the theme in the sensory presentation. Additionally or alternatively, a closing section can be provided for at least one of the themes. For example, each closing section can comprise visual and/or auditory signals to indicate the ending of the theme in the sensory presentation. In a further exemplary embodiment, each of the themes can comprise an opening and a closing section. It will be appreciated that other sections can also be included in a theme and are within the scope of the present invention.

At least one of the themes can be divided into one or more topics. In an exemplary embodiment, the theme “pet” can comprise multiple topics, such as dogs, cats, fish, birds, etc. In another exemplary embodiment, the theme “holidays” can be divided into multiple topics, such as New Year's Day, Memorial Day, Independence Day, Labor Day, Thanksgiving, Christmas, etc. It will be appreciated that other topics can also be used to form each of the themes and are within the scope of the present invention.

The topics can be formed in various manners. For example, visual (such as video) and/or sound (such as music) effects can be used in each topic. In an exemplary embodiment, one or more topics can be in a multimedia form, such as a music video. In a further exemplary embodiment, one or more topics can be prepared with a normal pace, such as a normal rate of speech, with or without visual supporting elements. For example, about 160 to 170 words can be spoken per minute. In a still further exemplary embodiment, one or more topics can be prepared using a normal tone and/or intonation.

The topics can also have various structures. For example, the topic can comprise a plurality of topical sessions. In one exemplary embodiment, at least one topic can comprise a development session during which the topic can be developed. For example, one of the stories of family life can be told, shown or otherwise presented to the recipient during the development session. The development session can be formed in various manners. In an exemplary embodiment, the development session can be in a multimedia form, such as a music video. The length of the development session can vary. In an exemplary embodiment, the development session can last for about 90 seconds.

Additionally or alternatively, the development session can be prepared following one or more of the production guidelines. In one exemplary embodiment, the content in this session can be developed using repetition, such as direct repetition, paraphrasing, or parallel actions by a different actor. For example, the content can be repeated at least three times. In another exemplary embodiment, the development session of each of the topics can use the repetition technique. It will be appreciated that other methods of preparing the development session are also within the scope of the present invention.

In another exemplary embodiment, at least one topic can comprise a summary session following the development session. The summary session can be in various forms to carry out one or more of the following tasks: summarize the purpose of the development session for the recipient, interact with the recipient, such as by asking for the recipient's comments on the sensory presentation, and/or provide a priming signal to the recipient to assist the recipient to react to the development session. The length of the summary session can vary. In an exemplary embodiment, the summary session can last for about 20 seconds.

In one exemplary embodiment, the summary session can comprise a priming signal for assisting the cognitively impaired individual in generating a cognitive, emotional, or physical response to the sensory presentation presented in the preceding development session. In an exemplary embodiment, the priming signal can be a cognitive, emotional, or physical response to the sensory presentation for the cognitively impaired individual to imitate. For example, the priming signal can be a model response, such as clapping, waving, laughing, and the like, to the sensory presentation in the development session. In another exemplary embodiment, the priming signal can cue a recognition response to the first sensory presentation. In an exemplary embodiment, the priming signal can be an accentuated signal. It will be appreciated that other forms of the priming signal are also within the scope of the present invention.

Additionally or alternatively, the summary session can be prepared following one or more of the production guidelines. For example, open-ended questions can be used in relation to recipient's feelings, opinions, or preferences for content in the sensory presentation, but are avoided otherwise. Similarly, questions requiring recollection of the previous events, or question requiring a series of answers are generally avoided. In an exemplary embodiment, the summary session can use a “yes/no” type of question to seek the recipient's comments on the development session. In another exemplary embodiment, the summary session can comprise video or audio representation (e.g., image, pre-recorded soundtrack, text) of the answer to a question asked in relation to the sensory presentation in the development session. It will be appreciated that other methods for preparing the summary session are also within the scope of the present invention.

In a further exemplary embodiment, at least one topic can comprise an introduction session, which can precede the development session. The introduction session can be in various forms to carry out one or more of the following tasks: explain the topic development session to the recipient, create the recipient's expectation, and encourage the recipient to participate. For example, a host can be employed to present the introduction session. The length of the introduction session can vary. For example, the introduction session can last for about 20 seconds. It will be appreciated that other methods for preparing the introduction session are also within the scope of the present invention.

The various topical sessions, such as the introduction session, the development session, and the summary session, can be joined with one another to form the sensory presentation. For example, the summary session can immediately follow the development session. In an exemplary embodiment, the sensory presentation can comprise a continuous multi-sensory signal to be presented to the recipient. In another exemplary embodiment, a transition segment can be provided to bridge two topical sessions and/or to provide continuity as will be described below.

The transition segment can be in various forms. In an exemplary embodiment, the transition segment can be prepared following one or more of the production guidelines. In an exemplary embodiment, the transition segment can comprise an element, such as a visual or auditory signal, contained in at least one the two topical sessions before and after the transition segment. For example, the transition segment can comprise an element common for both the topical sessions. In another exemplary embodiment, the transition segment can comprise a contextual cue. For example, the transition segment can comprise fade-outs long enough for the trace of the earlier content to dissipate. In an exemplary embodiment, the transition segment can fade to black, start new music while in black, and continue music into next topical session. The length of the transition segment can vary. In an exemplary embodiment, the transition segment can last for about five seconds. It will be appreciated that other methods for preparing the transition segment are also within the scope of the present invention.

In one exemplary embodiment, each topic can have a tempo effect. The tempo effect of a topic can be determined by various factors including, but not limited to, the content of the topic, the presentation of the topic (e.g., tone or intonation), and the pacing of the topic (e.g., rate of speech or rate of image change), or the like. In an exemplary embodiment, a “high” tempo topic can be prepared, in which more than 160 to 170 words can be spoken per minute. In an alternative exemplary embodiment, a “mild” tempo topic can be prepared, in which fewer than 160 to 170 words can be spoken per minute. It will be appreciated that other methods for forming the tempo effect of a topic are also within the scope of the present invention.

In another embodiment, a plurality of topics can be prepared with different tempo effects. For example, a slower tempo tends to elicit a calming response, while a faster tempo tends to elicit an excitatory response. In one exemplary embodiment, the topics of different tempo effects can be selected and arranged to obtain a changing tempo effect. For example, topics of progressively faster or slower tempo effects can be used to gradually stimulate or calm the recipient. When such topics are presented to the cognitively impaired individual, they can lower the agitation level of the individual. It will be appreciated that other methods for obtaining different tempo effects are also within the scope of the present invention.

According to a further aspect of the invention, a system can be provided which is capable of interacting with cognitively impaired individuals, such as entertaining or educating AD patients. In one embodiment, the system can comprise a primary sensory device and an ancillary sensory device for providing a sensory presentation to a cognitively impaired individual. The primary and ancillary sensory device can comprise at least one common theme. In an exemplary embodiment, the primary sensory device and the ancillary sensory device engage the cognitively impaired individual in generating a cognitive, emotional, or physical response to the sensory presentation.

The primary sensory device and the ancillary sensory device can be formed in various manners. In an exemplary embodiment, the primary sensory device can be the same or otherwise similar to the sensory presentation device described in any of the exemplary embodiments above. For example, the primary sensory device can be in the form of a multimedia device. It will be appreciated that other methods for preparing the primary sensory device are also within the scope of the present invention.

Additionally or alternatively, the ancillary sensory device can be formed to afford the user a different and additional sensory experience. In an exemplary embodiment, the ancillary sensory device can provide a tactile experience to the cognitively impaired individual. For example, the ancillary sensory device can comprise a scrapbook. In another exemplary embodiment, the ancillary sensory device can comprise an audio device. For example, the audio device can comprise a soundtrack which is the same as or similar to that in the primary sensory device. It will be appreciated that other methods for preparing the ancillary sensory device are also within the scope of the present invention.

In a further exemplary embodiment, the ancillary sensory device can be so formed that it can be used independently from the primary sensory device. In an exemplary embodiment, where the ancillary device can be a soundtrack device, the soundtrack device can be used alone. In another exemplary embodiment, various ancillary devices can be used with one another. For example, a scrapbook can be used by a cognitively impaired individual while listening to the soundtrack. It will be appreciated that other methods for using the ancillary sensory device are also within the scope of the present invention.

According to a still further aspect of the invention, a method can be provided for interacting with cognitively impaired individuals. In one embodiment, the method can comprise providing a first sensory presentation to a cognitively impaired individual. In one exemplary embodiment, the first sensory presentation can be prepared in various manners and forms, which can be similar to or the same as those of the sensory presentation described above. In an exemplary embodiment, the first sensory presentation can be prepared based on one or more cognitive, cognitive-perceptual, and/or functional abilities retained by the cognitively impaired individuals. It will be appreciated that other methods for preparing the first sensory presentation are also within the scope of the present invention.

In one exemplary embodiment, the method can comprise providing a priming signal to cue the recipient of the sensory presentation to generate a cognitive, emotional, or physical response to the sensory presentation. The priming signal can be formed in various manners, which can be similar to or the same as those described above. In an exemplary embodiment, the priming signal can be provided to the recipient by a model response through a host or a pre-recorded image or soundtrack. In another exemplary embodiment, the primary signal can be provided to the recipient immediately after the development session. It will be appreciated that other methods for preparing the priming signal are also within the scope of the present invention.

Additionally or alternatively, the method can comprise providing a second sensory presentation to the cognitively impaired individual. For example, the second sensory presentation can be in various forms to provide information to the recipient through a different or an additional sensory channel. In one exemplary embodiment, the second sensory presentation can comprise at least one common theme as in the first sensory presentation. For example, the second sensory presentation can be at least some or part of the images from the first sensory presentation to be formed on a scrapbook. Such a scrapbook can afford the recipient a tactile experience of the first sensory presentation. In another exemplary embodiment, a soundtrack of the first sensory presentation can be provided to the recipient to create an independent sensory experience, which will be further described below. It will be appreciated that other methods for preparing the second sensory presentation are also within the scope of the present invention.

The second sensory presentation can be provided to the recipient in various ways. For example, the second sensory presentation can be provided to the recipient before, simultaneously with, or after the first sensory presentation. In one exemplary embodiment, various devices carrying the second sensory presentation can be used independently from the first sensory presentation. For example, the cognitively impaired individual can be instructed to use the scrapbook while listening to the soundtrack. In another exemplary embodiment, the soundtrack can be used alone. It will be appreciated that other methods for using the second sensory presentation are also within the scope of the present invention.

The method can be operated in various manners to achieve different results. In one exemplary embodiment, the method can comprise repeating the above steps, such as to reinforce the result. For example, the method can be repeated the following day, in the same manner, at the same time, at the same place, and/or in the same setting. In an alternative exemplary embodiment, the method can be repeated daily.

Additionally or alternatively, the method can be operated to elicit an emotional response, such as to achieve a treatment result (e.g., meditation). For example, the sensory presentation can comprise a plurality of topics of various tempo effects. In an exemplary embodiment, the topics can be shown in the order of an increasing tempo effect to produce a stimulatory effect. In another exemplary embodiment, the topics can be arranged in the order of a reduced tempo effect to automatically lead to calming and a lower agitation level in the recipient. For example, the sensory presentation can be so formed that its tempo effect can reduce gradually. It will be appreciated that other operating methods are also within the scope of the present invention.

It will be appreciated that the methods, devices, and/or the system described above can be combined with various other methods, devices, or systems to achieve a comprehensive result in interacting with cognitively impaired individuals. Such combinations are also within the scope of the present invention. Although some of the above exemplary embodiments have been described mainly in connection with Alzheimer's disease, it will be appreciated that they can be applicable to other cognitive, cognitive-perceptual, and/or functional deficits directly or with modifications. Such applications and/or modifications are also within the scope of the present invention.

It will be appreciated that the various features described herein may be used singly or in any combination thereof. Therefore, the present invention is not limited to only the embodiments specifically described herein. While the foregoing description and drawings represent a preferred embodiment of the present invention, it will be understood that various additions, modifications, and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

1. A method of interacting with cognitively impaired individuals, comprising:
providing a sensory presentation to one or more of the cognitively impaired individual; and
providing a priming signal to cue the individual to generate a cognitive, emotional, or physical response to the sensory presentation;
wherein the sensory presentation is prepared based on a cognitive, cognitive-perceptual, and/or functional ability retained by the cognitively impaired individuals.

2. The method of claim 1, wherein the priming signal is a cognitive, emotional, or physical response to the first sensory presentation for the cognitively impaired individual to imitate.

3. The method of claim 1, wherein the priming signal cues a recognition response to the first sensory presentation.

4. The method of claim 1, wherein:
the first sensory presentation comprises a plurality of topics with different tempo effects; and
the topics are presented in the order of a progressively slower tempo effect.

5. The method of claim 1, wherein the sensory presentation to the cognitively impaired individual, wherein the first and second sensory presentations comprise at least one common theme.

6. The method of claim 6, wherein the sensory presentation comprises multi-sensory signals which are continuously presented to the cognitively impaired individual.

7. The method of claim 1 further comprising repeating the steps in claim 1 in the same context, at the same time of day, at the same place, and in the same setting.

8. A method of preparing a sensory presentation for interacting with cognitively impaired individuals, comprising:
identifying a cognitive, cognitive-perceptual, and/or functional ability retained by a group of cognitively impaired individuals having a similar type of cognitive impairment; and
producing a sensory presentation based on the retained ability of the group of individuals;
whereby the sensory presentation, after being presented to a cognitively impaired individual of the group, assists the individual to generate a cognitive, emotional, or physical response to the sensory presentation.

9. The method of claim 8 further comprising developing one or more production guidelines based on the retained cognitive, cognitive-perceptual, and/or functional ability identified, wherein the sensory presentation is produced based on the one or more production guidelines.

10. The method of claim 9, wherein the one or more production guidelines are formed based on one or more of the following retained abilities:
sustained attention, selective attention, working or short-term memory, long-term memory, habit memory, ability to learn new habits, response to conditioning, response to new stimuli, reading and writing ability ability to understand and respond to gestures, ability to follow multiple step commands, ability to answer questions, ability to understand grammar, syntax, and automatic phrases, auditory prosidy processing, auditory attention, visual spatial contrast sensitivity, static visual acuity, stereoacuity, dynamic visual acuity, motion direction discrimination, visual attention, visual shape-from-motion, color discrimination, visuospatial construction, and visual memory, and functional ability to perform activities of daily living.

11. The method of claim 9, wherein the one or more production guidelines comprise one or more of the following categories: avoiding changing topics, directing recipients to attention, keeping it simple, foreshadowing events with concrete representations, using repetition, engaging habit memory, engaging emotional response, using sensory channels, using printed text and simple dialog, using word choice, using open-ended questions, using normal pacing, using stationary objects for recognition, using high-contrast images, using color contrast, using expected visual orientation, centering focus objects in the visual field, and using living objects.

12. A sensory presentation device for interacting with cognitively impaired individuals, comprising a sensory presentation formed on a medium;
wherein the sensory presentation comprises one or more themes prepared based on one or more cognitive, cognitive-perceptual, and/or functional abilities retained by the cognitively impaired individuals.

13. The sensory presentation device of claim 12, wherein at least one of the one or more themes comprises one or more topics of different tempo effects.

14. The sensory presentation device of claim 12, wherein at least one of the one or more themes comprises one or more topics, at least one of which comprises a development session in a multimedia form.

15. The sensory presentation device of claim 12, wherein:
at least one of the one or more themes comprises one or more topics,
at least one of the one or more topics comprises a plurality of topical sessions and a transition segment bridging the topical sessions.

16. The sensory presentation device of claim 14, wherein the topic comprises a priming signal for assisting the cognitively impaired individual in generating a cognitive, emotional, or physical response to the sensory presentation.

17. A system for interacting with cognitively impaired individuals, comprising:
a primary sensory device for providing a sensory presentation to a cognitively impaired individual, the sensory presentation comprising at least one theme; and
an ancillary sensory device comprising at least one common theme as that of the primary sensory device;
wherein the primary sensory device and the ancillary sensory device engage the cognitively impaired individual in generating a cognitive, emotional, or physical response to the sensory presentation.

18. The system of claim 17, wherein the ancillary sensory device provides a different and additional sensory experience.

19. The system of claim 17, wherein the ancillary sensory device provides a tactile experience to the cognitively impaired individual.

20. The system of claim 17, wherein the ancillary sensory device comprises a scrapbook and/or memory book.
